(19) United States
(12) Patent Application Publication
(10) Pub. No.: US 2003/0193613 A1
(43) Pub. Date: Oct. 16, 2003

(54) Side mirror mount for a camera

(76) Inventors: Mark A. Matko, North Olmsted, OH (US); Craig S. Haehn, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/123,681

(22) Filed: Apr. 16, 2002

(51) Int. Cl. H04N 5/225; H04N 5/33

(52) U.S. Cl. 348/375; 348/335; 348/164; 348/216.1

(57) ABSTRACT

A viewing system for use in connection with vehicles includes a camera (70), which may include night vision functionality, mounted in a side view mirror assembly (20). A forward facing aperture (24) is formed in a mirror housing (22) to provide an unobstructed opening for the camera. The camera is suitably positioned so as not to interfere with power adjustment features associated with the mirrors and to provide a perspective view substantially similar to that of the driver looking directly through the windshield. In addition, the camera is easily accessible for cleaning and aesthetically blends in with the vehicle.

### BACKGROUND OF THE INVENTION

Field of the Invention

This application is generally directed to a camera system for a vehicle, and more particularly to a side mirror mounting arrangement for a night vision camera.

Camera systems and, more specifically, night vision systems are generally known in the art. Camera systems provide the driver of a vehicle enhanced viewing of the surrounding environment, by providing a wider field of vision or improved visability when it is dark. As an example of such camera system use, infrared cameras and similar devices have been used to improve night vision capability in a wide variety of applications. Although more widely used in military or aerospace applications, the decreasing cost of the night vision system has also led to a more recent suggested widespread use on commercial vehicles such as trucks and buses. The night vision equipment provides for improved vision at night when little or no ambient light is available.

A number of issues still remain, however, in adapting a night vision system to a commercial vehicle. For example, a primary issue relates to the fact that the camera is fairly large and is therefore difficult to conceal on the front of a truck. It is preferred that the system be hidden from view, or at least be aesthetically pleasing.

Still another issue is the need to maintain the camera perspective as close as possible to the perspective of the driver. It is important that the camera maintain the primary directions, UP, DOWN, LEFT, RIGHT, that correspond to that of the driver, and the same angle relative to the road as seen by the driver so that the driver can obtain information that can easily be understood. For example, cameras that are placed above the windshield, for example, as a replacement for one of the overhead running lights or overhead storage compartment, are ultimately disposed at a height substantially above the normal field of vision of the driver.

Still another issue is that the night vision camera is unable to obtain reliable data through glass or plastic. Thus, an unobstructed opening to view the roadway is required.

It is also desired that the camera be located at a region that allows the driver to easily clean the window of the camera. Any location deemed too high makes periodic cleaning of the window impractical.

Accordingly, a need exists for a simple, practical solution that overcomes the deficiencies in the prior art to effectively incorporate a night vision system into a heavy vehicle.

### BRIEF SUMMARY OF THE INVENTION

A system and method of enhancing a driver's view or vision by providing an improved field of vision or improved visibility is provided. One aspect of the present invention is to enhance a driver's view or vision while maintaining substantially the same perspective as the would be seen through the windshield of the vehicle.

In one embodiment a viewing system for commercial vehicles is provided and includes a camera mounted in a side view mirror housing. A window of the camera faces outwardly from the interior of the side mirror housing and through an aperture formed in the mirror housing.

Another embodiment of the present invention is a preferred method of mounting the camera includes the step of providing an opening in a mirror housing that faces outwardly and mounting a camera within the mirror housing and aligned with the opening in the housing.

### BRIEF DESCRIPTION OF THE DRAWINGS

FIG. 1 is a front elevational view of a truck cab, particularly the driver's side portion thereof.

FIG. 2 is a plan view of a modified side view mirror housing.

FIG. 3 is a schematic representation of the camera located adjacent to a rear side of a heated mirror.

FIG. 4 is an exploded view of a conventional night vision or infrared camera.

### DETAILED DESCRIPTION

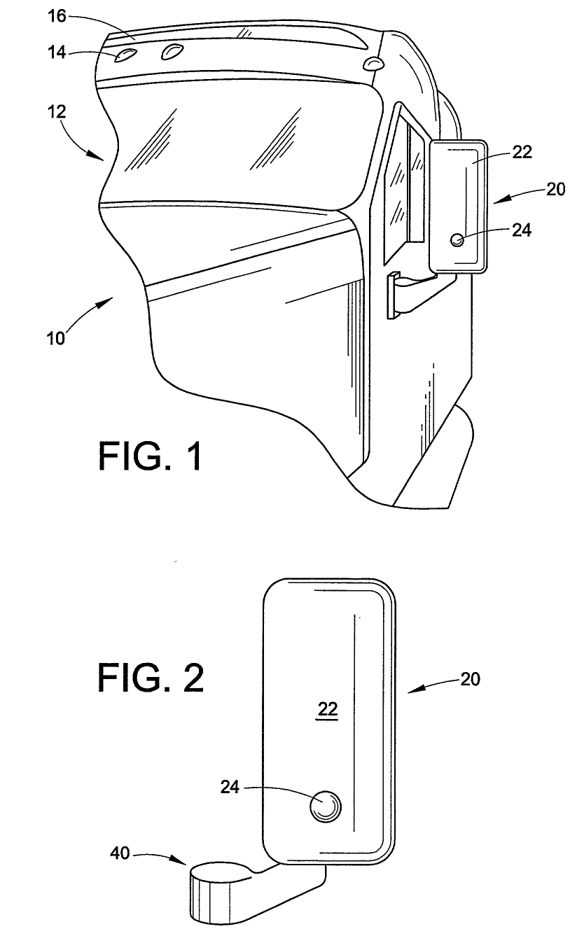

With reference to FIG. 1, a commercial vehicle such as, for example, a truck or tractor 10 is modified to incorporate a camera system. In one embodiment, the camera system is a night vision camera. A display unit 11 is disposed within a truck cab 12.

In accordance with one aspect of the present invention a forward facing camera is located in a region and with an orientation that approximates the perspective of the driver. In this manner, the driver directly views the road through the windshield from substantially the same perspective as the display of the night vision system. Furthermore, such location prevents the decrease in lighting or the decrease in comfort space available to the driver if the camera system was placed in place of an overhead running light 14 or in the storage compartment region 16, respectively.

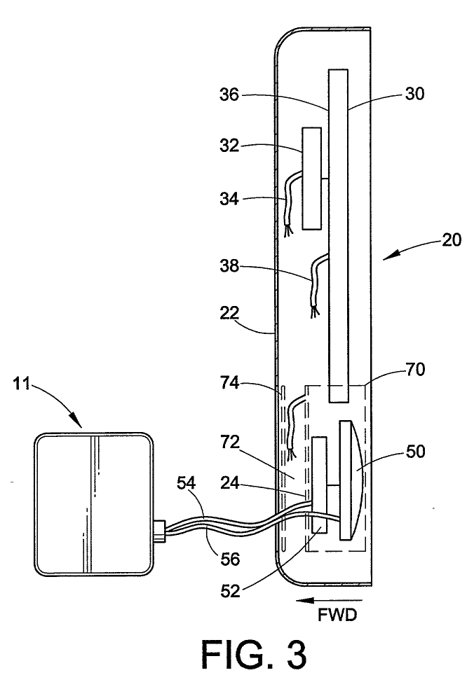

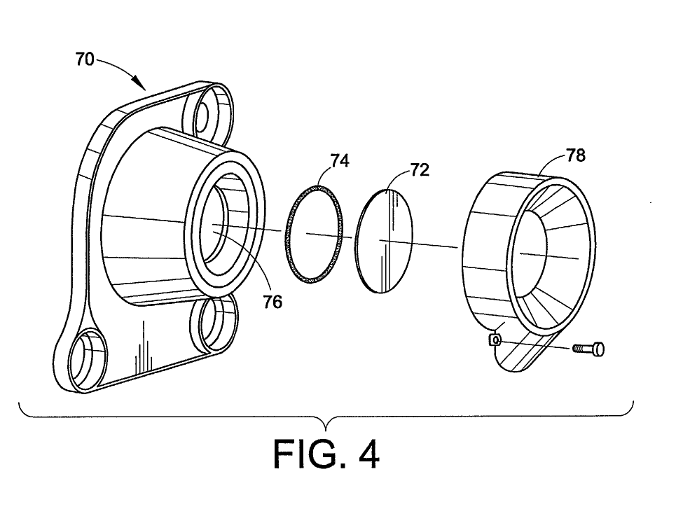

According to the present invention, a side view mirror assembly 20 is design to incorporate the night vision camera. Additionally, it should be noted that existing side mirror assemblies can be modified in accordance with the description herein to incorporate the night vision camera. A housing 22 of the side view mirror assembly 20 faces forwardly and contains an opening or aperture 24 therein. As shown in greater detail in FIG. 2, the side view mirror assembly has a housing of an elongated height and typically includes a pair of mirrors, as is well known in the art. For example, a planar, first mirror 30 provided in an upper portion of the housing (approximately the upper two-thirds (⅔) of the housing) faces generally rearwardly. As illustrated in greater detail in FIGS. 3 and 4, this first mirror is secured to an adjustable mounting or support member 32. A control assembly, for example first and second adjustment motors (not shown), provide for selective manipulation of the mirror about vertical and horizontal axes to orient the mirror as desired. This selective adjustment is controlled from within the cab in a manner well known in the art so that further discussion of that structure and function is deemed unnecessary to a full and complete understanding of the present invention. Suitable power and control wiring is illustrated at 34 as extending from the rear of the support member 32 for electrical control of the selective adjustment of the first mirror. The wiring 34 is routed to an appropriate control device (not shown) within the cab.

In addition, a rear face 36 of the first mirror typically incorporates a heater. Again, the structure and operation of the heating mechanism for a side view mirror of this type is conventional so that further description is not required. Power wiring 38 leads from the heater and through a common harness that proceeds through support arm 40 (FIGS. 1 and 2) of the side view mirror assembly 20 so that the wiring harness is protected along its path into the truck cab.

A second mirror, such as convex mirror 50, may mounted on an adjustable support member 52. The second mirror is also adjustable, preferably being motor driven as represented by the power and control wires 54. In addition, wires 56 lead from a rear face of the second mirror and provide a power source to a heater, which is typically incorporated into the rear surface of the mirror. In a similar manner as described above with respect to the first mirror, a truck operator can advantageously adjust the second mirror to a desired angle and use the heater as desired.

Camera 70 is relatively large and can accommodated adjacent the second mirror 50 and its associated adjustable support member 52 (FIG. 4). In one embodiment of the present invention the camera is a night vision camera, such as an infrared camera. The camera 70 includes a window 72 secured with a seal ring 74 over a lens 76 of the camera (FIG. 4). A bezel heater assembly 78 can be located over and around the window 72 to provide additional heat, if so desired. The window 72 is closely received within the aperture 24 formed in the housing as illustrated in FIG. 3. As will be appreciated, if the camera 70 is a night vision camera, no further transparent cover over the camera window 72 is desired since this would interfere with desired operation of the night vision camera. Rather, the window 72 is accessible externally to the mirror assembly through the aperture 24. Since the aperture is located in the lower one-third (⅓) of the elongated mirror housing, the window can be easily accessed for cleaning. Moreover, wiring 84 associated with input and output functions of the camera 70 can be easily bundled with the remaining wires 34, 38, 54, 56 and commonly fed through the support arm 40 of the mirror assembly into the truck cab. In addition, the camera 70 can be located adjacent the heaters associated with the rear face of the first or second mirror to provide additional heating, if so desired. Additionally, the camera 70 may be equipped with an internal heater.

The camera 70 is conveniently concealed within the mirror housing. While the camera system can be designed to be located in any of the side mirrors on a commercial vehicle, locating the camera system within the driver's side mirror provides a perspective substantially similar to the driver's view through the windshield. In addition, the camera is exposed directly to the road without any interference from a transparent cover or windshield and is easily accessible for cleaning. However, one skilled in the art would appreciate that the camera system described above can be mounted in the passenger side mirror or the camera system can provide data from cameras in both the driver's side and passenger side mirrors, either individually or simultaneously. One skilled in the art would also appreciate that the camera system described above can be used to provide information from a rearward perspective, by providing an aperture among the mirror faces, such as between the first and second mirrors. Alternatively, the rearward facing camera or cameras within the camera system may be located behind one of the mirrors if the mirrors were designed as one-way mirrors. However, if night vision functionality is desired, the camera would need to be designed such that the mirror would be obscure the data generated by the night vision camera.

In one embodiment, the night vision camera is Part No. 5008214 commercially available from Bendix Commercial Vehicle Systems. Of course, it will be appreciated that other commercially available cameras can be used without departing from the scope and intent of the present invention. Likewise, the side view mirror housing shown in the drawings and described above is available on a Kenworth T2000 truck cab. However, the invention should not be limited to this particular style of side view mirror assembly, nor be constrained for use on this particular brand of vehicle cab.

The invention has been described with reference to an illustrative embodiment. Obviously, modifications and alterations will occur to others upon a reading and understanding of the preceding detailed description. It is intended that the invention be construed as including all such alterations and modifications insofar as they come within the scope of the appended claims or the equivalents thereof.

What is claimed is:

1. A viewing system for a vehicle comprising:
a camera having a window assembly;
a side view mirror assembly adapted to be mounted on the vehicle, said side view mirror assembly having a housing; and
an opening in the housing surface dimensioned to accommodate the camera window.

2. The viewing system of claim 1, wherein said camera is a night vision camera.

3. The viewing system of claim 1, wherein said side view mirror housing comprises a surface facing forwardly of the vehicle and a mirror facing rearwardly of the vehicle.

4. The viewing system of claim 1 wherein the camera is mounted in the housing.

5. The viewing system of claim 4 wherein the camera is mounted between the mirror and the housing.

6. The viewing system of claim 4 wherein the assembly includes a bracket supporting the mirror in the housing, the camera being mounted to the bracket to support the camera in the housing.

7. The viewing system of claim 1 further comprising a heater for selectively heating the mirror assembly.

8. The viewing system of claim 7 wherein the camera being disposed in the housing adjacent the heater

9. The viewing system of claim 1 further comprising a wiring harness extending from the camera to the interior of the vehicle.

10. The viewing system of claim 1, wherein the vehicle is a truck or bus.

11. A method of mounting a camera to a vehicle comprising the steps of:
providing an opening in a side view mirror assembly; and
mounting the camera within the mirror assembly to view through the opening in the side view mirror assembly.

12. The method of claim 11, wherein the providing step further comprises the step of closely dimensioning the opening to a window dimension of the camera.

13. The method of claim 11, wherein the providing step includes positioning the camera adjacent a heater for the side view mirror.

14. The method of claim 11, wherein the camera is a night vision camera.

15. The method of claim 11 wherein the mounting step includes the step of securing the night vision camera to a bracket that supports a mirror in the assembly.

16. A night vision assembly for a heavy vehicle comprising:
a night vision camera having an aperture for receiving infrared energy therethrough; and
a side view mirror assembly having a housing and a side view mirror received in the housing with the camera, the mirror facing in a first, rearward direction and an opening formed in the housing facing in a second, frontward direction through which the camera aperture is directed.

17. The assembly of claim 16, wherein the housing opening is closely dimensioned to a dimension of the aperture.

18. The assembly of claim 16, wherein the camera is interposed between the housing and the mirror.

19. The assembly of claim 16, further comprising a heater disposed in the housing for selectively heating the mirror.

20. The assembly of claim 19, wherein the camera is disposed adjacent the heater.

21. The assembly of claim 19, wherein a common wiring harness includes wiring for the heater and night vision camera.

22. The assembly of claim 21, wherein the wiring harness further includes wiring for power to the heater.

23. The assembly of claim 21, wherein the wiring harness further includes wiring for power to the mirror, wiring for a heater associated with the mirror, and infrared camera window heater.

24. A viewing system comprising:
a camera having a viewing aperture;
a mirror assembly having a housing in which said camera is received;
a vehicle to which said mirror assembly is attached; and
a display unit located within the interior to the vehicle, said display unit receiving data from said camera.

25. The viewing system of claim 24, wherein said camera is a night vision camera.

26. The viewing system of claim 24, wherein said mirror housing comprises a surface facing forwardly of the vehicle and a mirror facing rearwardly of the vehicle.

27. The viewing system of claim 24 further comprising one or more heaters for selectively heating the mirror assembly.

28. The viewing system of claim 27, wherein said heaters include a bezel heater located around the viewing aperture.

29. The viewing system of claim 24 further comprising a wiring harness extending from the camera to the interior of the vehicle.

30. The viewing system of claim 24, wherein the vehicle is a truck or bus.
